(19) United States
(12) Patent Application Publication
(10) Pub. No.: US 2026/0362416 A1
(43) Pub. Date: Nov. 12, 2026

(54) TRIGGER-BASED PHYSICAL LAYER PROTOCOL DATA UNITS IN INTEGRATED MILLIMETER WAVE OPERATION

(71) Applicant: Cisco Technology, Inc., San Jose, CA (US)

(72) Inventors: Matthew Aaron Silverman, Shaker Heights, OH (US); Peiman Amini, Fremont, CA (US); Ardalan Alizadeh, Milpitas, CA (US); Brian D. Hart, Sunnyvale, CA (US)

(21) Appl. No.: 19/674,803

(22) Filed: May 12, 2026

Related U.S. Application Data
(60) Provisional application No. 63/804,442, filed on May 12, 2025.

(51) Int. Cl. H04W 72/1268; H04L 5/00; H04W 72/0453; H04W 84/12

(52) U.S. Cl. CPC H04W 72/1268; H04L 5/0094; H04W 72/0453; H04W 84/12

(57) ABSTRACT

Support for trigger-based Physical Layer Protocol Data Units (TB-PPDUs) in Integrated millimeter Wave (ImmW) operation may be provided. Supporting TB-PPDUs in ImmW includes generating, by an access point (AP), a trigger frame scheduling an uplink (UL) transmission from a client device in an ImmW frequency band. The AP then transmits the trigger frame to the client device. In response to the trigger frame, the AP receives a TB-PPDU from the client device, wherein the TB-PPDU comprises a signal (SIG) field of a physical layer preamble comprising a first repurposed bit set to a value indicating a transmission direction of the TB-PPDU and a second repurposed bit set to a value indicating that the TB-PPDU is trigger-based.

### RELATED APPLICATION

Under provisions of 35 U.S.C. § 119(e), Applicant claims the benefit of and priority to U.S. Provisional Application No. 63/804,442, filed May 12, 2025, the disclosure of which is incorporated herein by reference in its entirety.

### TECHNICAL FIELD

The present disclosure relates generally to providing support for trigger-based physical layer protocol data units in integrated millimeter wave operation.

### Background

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing support for trigger-based Physical Layer Protocol Data Units (TB-PPDUs) in Integrated millimeter Wave (ImmW) operation in accordance with aspects of the present disclosure.

FIG. 2 illustrates a Very High Throughput (VHT)-Signal (SIG)-A1 symbol of a VHT-SIG-A field in accordance with aspects of the present disclosure.

FIG. 3 illustrates a VHT-SIG-A2 symbol of a VHT-SIG-A field in accordance with aspects of the present disclosure.

FIG. 4 illustrates a common info field of a trigger frame in accordance with aspects of the present disclosure.

FIG. 5 illustrates a user field of a trigger frame in accordance with aspects of the present disclosure.

FIG. 6 illustrates a signaling process for supporting TB-PPDUs in ImmW operation in accordance with aspects of the present disclosure.

FIG. 7 is a flow diagram illustrating a method for TB-PPDUs in ImmW in accordance with aspects of the present disclosure.

FIG. 8 is a block diagram of a computing device in accordance with aspects of the present disclosure.

FIG. 9 is a block diagram of a communications device in accordance with aspects of the present disclosure.

### DETAILED DESCRIPTION

### Overview

Support for trigger-based Physical Layer Protocol Data Units (TB-PPDUs) in Integrated millimeter Wave (ImmW) operation may be provided. Supporting TB-PPDUs in ImmW includes generating, by an access point (AP), a trigger frame scheduling an uplink (UL) transmission from a client device in an ImmW frequency band. The AP then transmits the trigger frame to the client device. In response to the trigger frame, the AP receives a TB-PPDU from the client device, wherein the TB-PPDU comprises a signal (SIG) field of a physical layer preamble comprising a first repurposed bit set to a value indicating a transmission direction of the TB-PPDU and a second repurposed bit set to a value indicating that the TB-PPDU is trigger-based.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### Example of Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Institute of Electrical and Electronics Engineers (IEEE) 802.11bq working group is developing standards focused on Integrated millimeter Wave (ImmW) operation. ImmW operation uses high-frequency, unlicensed bands between 42 Gigahertz (GHz) and 71 GHz (e.g., at 60 GHz). These high frequencies enable fast data rates over short ranges, making ImmW well-suited for high-speed, short-range bursts of data transmission (e.g., for streaming video, wireless docking, virtual reality, and augmented reality applications), while traditional bands, such as 2.4 GHz, 5 GHz, and 6 GHz, continue to provide broader coverage and reliability. Because ImmW is limited to single-user (SU) transmissions, such as SU Orthogonal Frequency-Division Multiplexing (OFDM) transmissions, Multi-User (MU) capabilities, including Multi-User, Multiple-Input, Multiple-Output (MU-MIMO), are not supported.

Very High Throughput (VHT) (i.e., Wi-Fi 5) format Physical (PHY) layer frames are used in ImmW operation for several reasons. First, operation at ImmW bands such as 60 GHz is more susceptible to phase noise compared to sub-7 GHz bands, and the VHT subcarrier spacing (applied in ImmW as a static, upclocked integer multiple of the VHT subcarrier spacing) provides improved phase noise tolerance suited to these frequencies. Second, using VHT frames allows devices to leverage existing silicon and hardware implementations. Third, VHT frames provide a foundation from which features beyond those originally defined in IEEE 802.11ac/VHT can be developed for ImmW operation. VHT PHY layer frames include VHT-Signal (SIG) fields, specifically VHT-SIG-A and VHT-SIG-B, in the frame preamble. VHT-SIG-A contains information necessary for all users to interpret a packet, including channel bandwidth, group identifier (ID), and Modulation and Coding Scheme (MCS), and is spread across two symbols: VHT-SIG-A1 and VHT-SIG-A2. VHT-SIG-B contains user-specific information, such as the length of the data field, and includes reserved bits whose quantity depends on the channel bandwidth.

Because ImmW restricts operation to SU transmissions only, a number of bits within the VHT-SIG fields that were designed to support MU operation become unnecessary. Specifically, the six Group ID bits in VHT-SIG-A, which identify MU transmission groups, carry no meaningful information in the SU-only ImmW context. Similarly, Space-Time Block Coding (STBC) is not planned to be supported in ImmW and is being phased out beginning with IEEE 802.11bn, making the STBC bit in VHT-SIG-A likewise unnecessary. In addition, VHT-SIG-A includes three reserved bits, and VHT-SIG-B includes two to three reserved bits depending on bandwidth, none of which carry defined information. Further, because ImmW supports fewer spatial streams than sub-7 GHz operation, two of the three Number of Spatial Streams (NSS) field bits (e.g., comprising Number of Space-Time Streams (NSTS) bits) and one or more of the four MCS bits are also candidates for repurposing, yielding additional available bits. Across VHT-SIG-A, this results in approximately ten to thirteen bits that serve no functional purpose in ImmW operation and can be repurposed for other features. Additionally, two to three bits of VHT-SIG-B are able to be repurposed, for a maximum total of approximately sixteen usable bits across both SIG fields. The techniques described herein may also be extended beyond VHT format to other PHY formats whose SIG fields contain analogous unused or inapplicable bits, including High Efficiency (HE) (802.11ax) and Extremely High Throughput (EHT) (802.11be) formats.

Among other uses, any of these available bits in the VHT-SIG fields can be used for supporting trigger-based (TB) Physical Layer Protocol Data Units (PPDUs). Because VHT format was not originally designed to support TB-PPDU operation, certain signaling capabilities are introduced into the VHT-SIG-A field analogous to those defined in HE-Signal (HE-SIG) and Universal-Signal (U-SIG) fields of HE and EHT formats, respectively. Specifically, bits corresponding to HE-SIG or U-SIG functionality can be mapped to various combinations of the available Group ID, STBC, and reserved bits, as well as portions of the MCS and NSS fields, within VHT-SIG-A. One of the available bits serves as an Uplink (UL)/Downlink (DL) bit for indicating transmission direction. The UL/DL bit is set to a first value (e.g., 0) to indicate DL and a second value (e.g., 1) to indicate UL. Another available bit serves as a Format bit indicating whether the PPDU is trigger-based. The Format bit is set to a first value (e.g., 0) to indicate the PPDU is not trigger-based and a second value (e.g., 1) to indicate the PPDU is trigger-based.

Supporting TB-PPDUs in ImmW also includes corresponding changes to the trigger frame itself. The existing trigger frame format, defined for HE and EHT operation, contains fields that are specific to those formats and to multi-user operation, rendering them inapplicable in the ImmW SU context and making them candidates for repurposing or removal. In the Common Info field of the trigger frame, two bits used for GI/HE-LTF Type/TXS Mode signaling are no longer needed because the subcarrier spacing in ImmW is based on a static, upclocked integer multiple of the VHT subcarrier spacing rather than dynamically signaled HE/EHT values. In one embodiment, these two bits are reduced to a single bit for guard interval (GI) signaling, analogous to the VHT approach of indicating 800 nanoseconds (ns) versus 400 ns GI. The STBC bit in the Common Info field can similarly be removed or repurposed, as ImmW operation is restricted to Low-Density Parity-Check (LDPC) coding only, and midamble-related bits in the Common Info field can likewise be removed. With respect to the Trigger Type subfield, techniques described herein introduce two new trigger types using currently reserved subfield values. In one embodiment, an ImmW in-band trigger type is defined to trigger an upclocked VHT-format SU PPDU within the ImmW band; this trigger type also signals that the trigger frame contents are without HE/EHT-specific fields such as those described above. In another embodiment, a Cross-MLD Trigger type is defined to enable triggering of ImmW operation from a sub-7 GHz channel, indicating that the trigger is intended not for the sub-7 GHz radio but for the ImmW radio in the 60 GHz band. The UL Bandwidth (BW) subfield of the Common Info field is likewise modified to represent channel bandwidths applicable to ImmW, with subfield values redefined to represent 160 MHz, 320 MHz, 640 MHz, and 1280 MHz, respectively. In another embodiment, the field is reduced to a single bit representing 160 MHz and 320 MHz. Finally, the User Info field of the trigger frame is modified for SU operation: the Resource Unit (RU) allocation subfield and the UL Target Received Power subfield, both of which are specific to multi-user scenarios, are no longer needed in ImmW and can be removed or repurposed for ImmW-specific signaling.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, as used herein, reference to reading, writing, storing, buffering, and/or transferring data can include the entirety of the data, a portion of the data, a set of the data, and/or a subset of the data.

The terms “or,” “and/or,” “at least one of,” and “one or both of” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

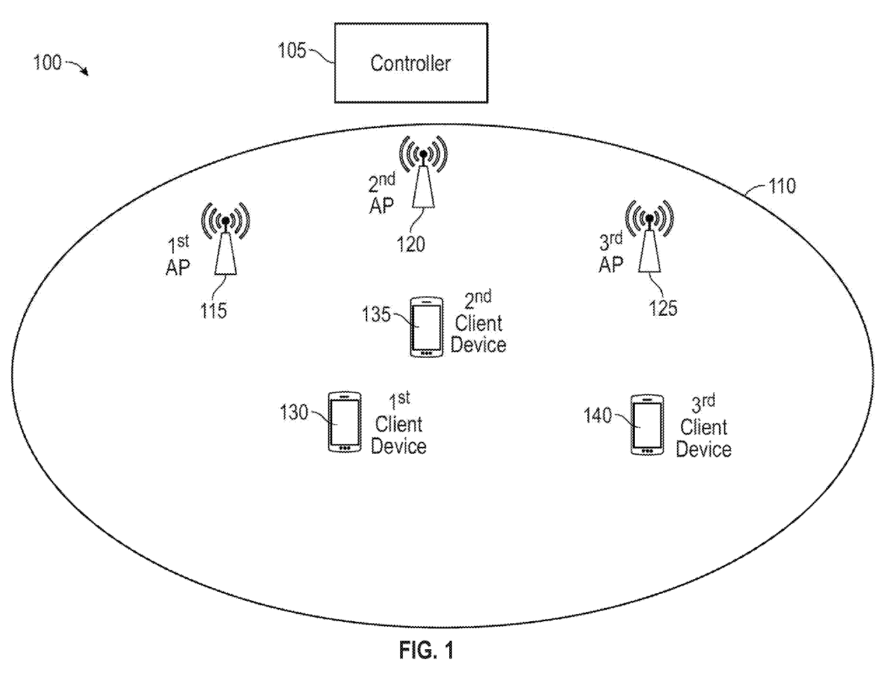

FIG. 1 illustrates an example operating environment 100 for supporting TB-PPDUs in ImmW operation. As shown in FIG. 1, operating environment 100 comprises a controller 105, a database 107, and a coverage environment 110. Coverage environment 110 comprises a Wireless Local Area Network (WLAN) comprising a plurality of APs that provide wireless network access for client devices. In the illustrated embodiment, the APs comprise a first AP 115, a second AP 120, and a third AP 125, though the plurality of APs may comprise any number of APs in further embodiments.

The APs provide wireless network access to client devices (e.g., STAs) within coverage environment 110. In the illustrated embodiment, the client devices comprise a first client device 130, a second client device 135, and a third client device 140. A client device may be any device capable of wirelessly connecting to the network, such as a smartphone, a personal computer, a tablet, a mobile device, a telephone, a remote control device, a set-top box, a digital video recorder, an Internet-of-Things (IoT) device, a network computer, a router, a Virtual Reality (VR)/Augmented Reality (AR) device, or other similar microcomputer-based device. The APs and client devices may be compatible with specification standards such as the IEEE 802.11 specification standard, including IEEE 802.11ad, IEEE 802.11ay, and IEEE 802.11bq. In some embodiments, the APs and client devices are implemented as Multi-Link Devices (MLDs) that support concurrent operation over both sub-7 GHz and ImmW frequency bands, enabling cross-band trigger frame delivery as described herein.

The APs and client devices may communicate using one or more wireless communication protocols, including IEEE 802.11-based protocols. The wireless communications may utilize ImmW frequency bands between 42 GHz and 71 GHz, including for example communications at 60 GHz. In some implementations, the devices may additionally communicate using lower-frequency Wi-Fi bands, such as 2.4 GHz, 5 GHz, or 6 GHz bands, for broader coverage and reliability alongside the high-speed, short-range ImmW transmissions. The TB-PPDU techniques described herein enable APs to schedule UL transmissions from client devices by sending trigger frames within the ImmW band or from a sub-7 GHz band and receiving upclocked VHT-format TB-PPDUs from the triggered client devices in response.

The controller 105 comprises a WLAN controller that may provision and control the coverage environment 110, including permitting the first client device 130, the second client device 135, and the third client device 140 to join the coverage environment 110. In some embodiments, the controller 105 is implemented as a Digital Network Architecture Center (DNAC) controller (e.g., a Software-Defined Network (SDN) controller) that configures the APs to support TB-PPDUs in ImmW operation as described herein.

The operating environment 100 is provided solely as an illustrative example. In various implementations, the operating environment 100 may include additional or fewer controllers, APs, client devices, databases, network devices, communication links, or coverage relationships than those illustrated in FIG. 1. Further, although certain example components are illustrated as separate entities, some functions may be combined, distributed, virtualized, centralized, or otherwise implemented in different configurations.

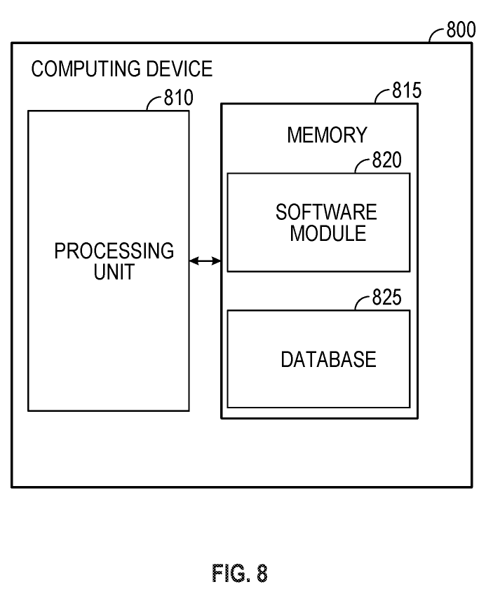

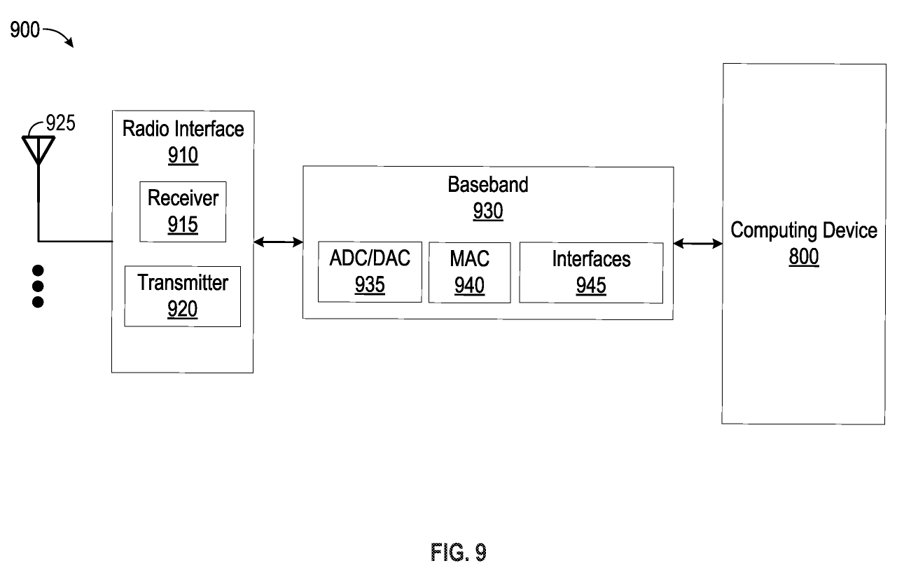

The elements described above of the operating environment 100 (e.g., the controller 105, the database 107, the first AP 115, the second AP 120, the third AP 125, the first client device 130, the second client device 135, the third client device 140, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 8 and 9, the elements of the operating environment 100 may be practiced in a computing device 800 and/or communications device 900.

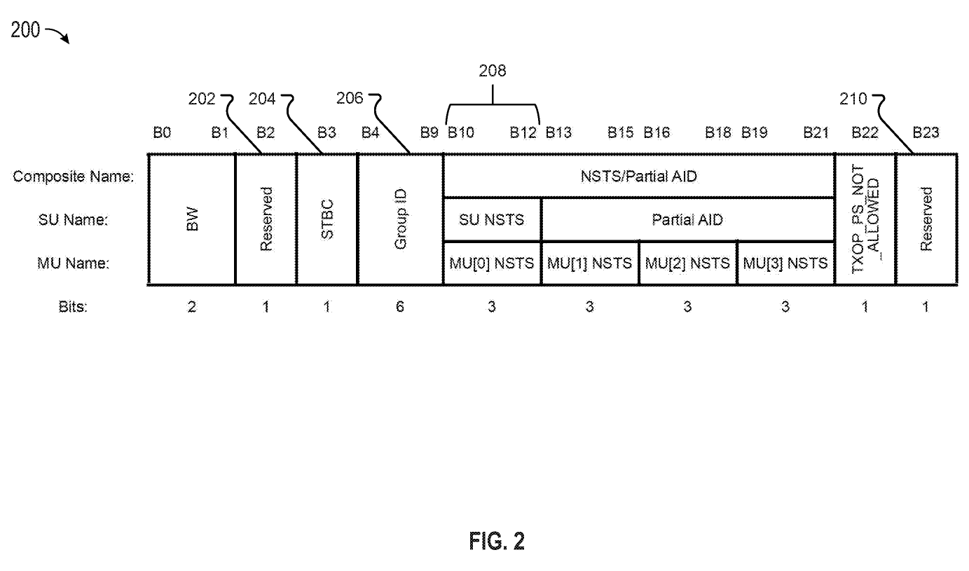

FIG. 2 illustrates a VHT-SIG-A1 symbol 200 of a VHT-SIG-A field. The VHT-SIG-A1 symbol 200 includes, among other bits and fields, a first reserved bit 202, an STBC bit 204, a Group ID field 206 six bits in length, an NSS field 208 three bits in length, and a second reserved bit 210. As illustrated, the NSS field 208 contains bits related to NSTS, which defines the number of space-time streams used in the transmission. In SU operation, NSTS is equivalent to NSS, so these bits effectively indicate the NSS.

As noted above, ImmW operation is limited to SU transmissions, and STBC is not planned to be supported in ImmW, as 60 GHz operation is intended to use Low-Density Parity-Check (LDPC) coding. As a result, certain bits within the VHT-SIG-A1 symbol 200 are unnecessary in the ImmW context and may be repurposed. Specifically, the first reserved bit 202 and the second reserved bit 210 carry no defined information and are available for repurposing. The STBC bit 204 is unnecessary because STBC is not supported in ImmW operation. The Group ID field 206 is unnecessary because MU transmissions are not supported in ImmW, rendering the group identifier irrelevant. Additionally, because ImmW does not support as many spatial streams as sub-7 GHz operation, two of the three bits of the NSS field 208 are also candidates for repurposing, as only a single bit is needed to indicate support for one or two spatial streams in the ImmW context.

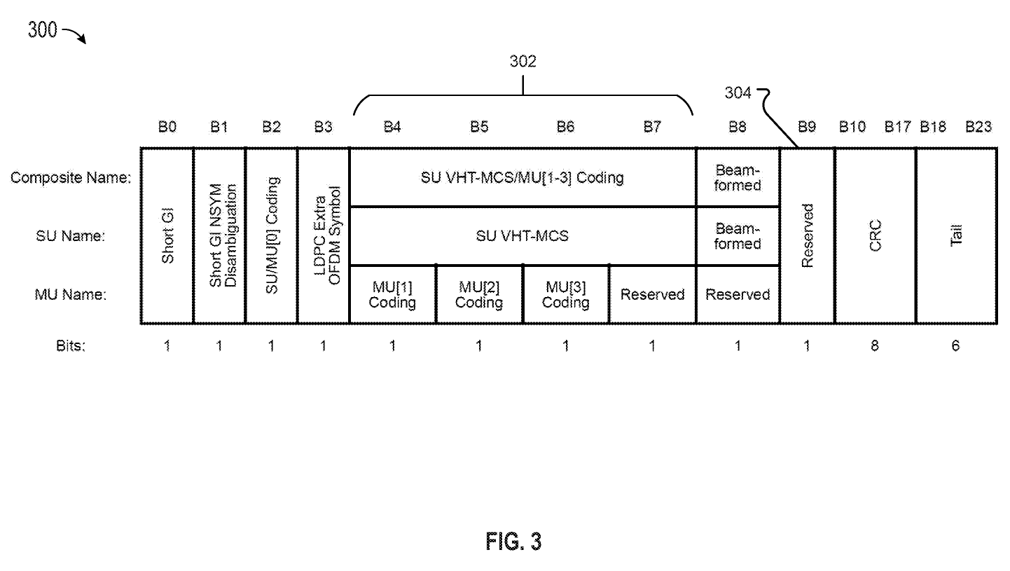

FIG. 3 illustrates a VHT-SIG-A2 symbol 300 of the VHT-SIG-A field. The VHT-SIG-A2 symbol 300 includes, among other bits and fields, an MCS field 302 four bits in length and a third reserved bit 304. The third reserved bit 304 carries no defined information and is available for repurposing. Additionally, because the range of MCS values applicable to ImmW operation is more limited than in sub-7 GHz operation, one of the four bits of the MCS field 302 is also a candidate for repurposing, with three bits sufficient to represent all MCS values supported in ImmW.

Accordingly, across the VHT-SIG-A1 symbol 200 and the VHT-SIG-A2 symbol 300, there are thirteen bits that are unnecessary or inapplicable in ImmW and are available for repurposing: the three reserved bits 202, 210, and 304; the six bits of the Group ID field 206; the STBC bit 204; two of the three bits of the NSS field 208; and one of the four bits of the MCS field 302.

Among other uses, any of these available bits in the VHT-SIG-A1 symbol 200 and VHT-SIG-A2 symbol 300 can be used for supporting TB-PPDUs. Specifically, bits corresponding to HE-SIG or U-SIG functionality can be mapped to various combinations of the available bits of the Group ID field 206, the STBC bit 204, and the reserved bits 202, 210, and 304, as well as portions of the MCS field 302 and NSS field 208. One of the available bits serves as a UL/DL bit for indicating transmission direction—set to a first value (e.g., 0) to indicate DL and a second value (e.g., 1) to indicate UL. Another available bit serves as a Format bit indicating whether the PPDU is trigger-based—set to a first value (e.g., 0) to indicate the PPDU is not trigger-based and a second value (e.g., 1) to indicate the PPDU is trigger-based.

In addition to the VHT-SIG-A1 symbol 200 and VHT-SIG-A2 symbol 300, VHT-SIG-B also contains bits that are available for repurposing in the ImmW context. VHT-SIG-B includes reserved bits (two reserved bits in some bandwidth configurations and three in others) whose quantity depends on the channel bandwidth, none of which carry defined information. These reserved bits of VHT-SIG-B may similarly be repurposed to carry ImmW-specific signaling, providing two to three additional available bits beyond those available in VHT-SIG-A. Taken together, the available bits across VHT-SIG-A1, VHT-SIG-A2, and VHT-SIG-B yield a maximum of approximately sixteen bits that may be repurposed for ImmW features, including the TB-PPDU signaling described herein.

Although FIGS. 2 and 3 illustrate bit repurposing in the context of VHT-SIG-A1 and VHT-SIG-A2, the same concept may be extended to SIG fields of other PHY formats. For example, in HE format, bits within the HE-SIG-A field that are inapplicable to ImmW SU operation may similarly be repurposed. Likewise, in EHT format, bits within the U-SIG field that are inapplicable in the ImmW context may be repurposed to carry the UL/DL, Format, and other ImmW-specific signaling described herein.

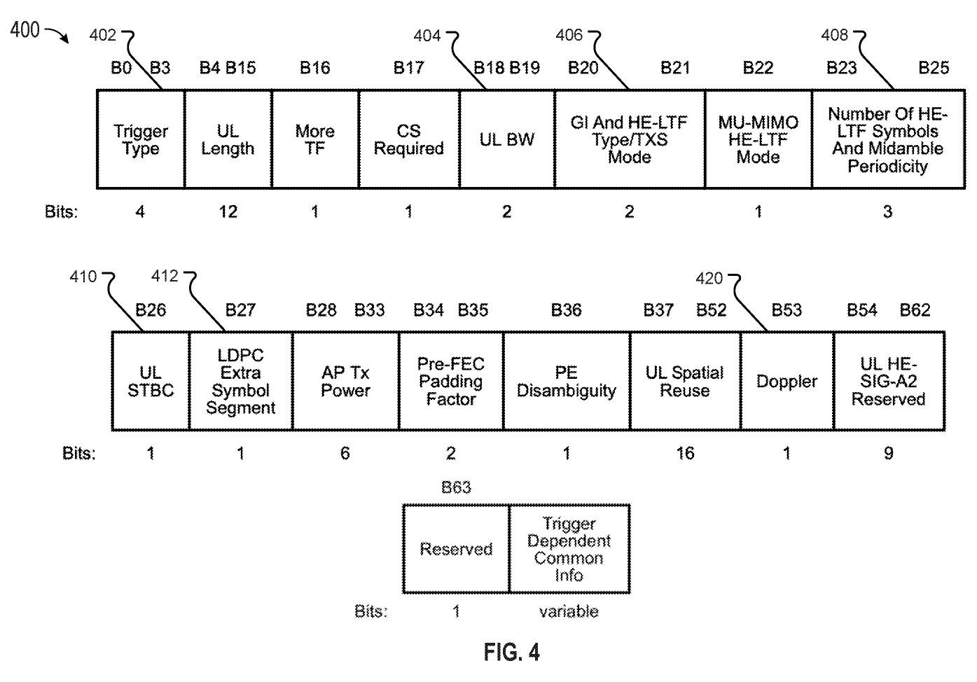

FIG. 4 illustrates a common info field 400 of a trigger frame. As illustrated, the common info field 400 includes, among other fields, a Trigger Type field 402, a UL BW field 404, a GI and HE-LTF Type/TXS Mode field 406, a Number of HE-LTF Symbols and Midamble Periodicity field 408, a UL STBC field 410, an LDPC Extra Symbol Segment field 412, and a Doppler field 420.

The Trigger Type field 402 indicates the type of the trigger frame. In one embodiment, a new ImmW in-band trigger type is defined, using a reserved value (e.g., one of values 8–15) to indicate this type. A trigger frame with the ImmW in-band trigger type indicates that it is intended to trigger an upclocked VHT-format SU PPDU in the ImmW band. A trigger frame of this type also indicates that its contents do not include HE/EHT-specific fields, consistent with the modified common info and user info field formats described herein.

In another embodiment, an AP may send a trigger frame in a sub-7 GHz band to trigger UL ImmW operation. In such a case, a new Cross-MLD Trigger type is defined, also using a reserved value (e.g., one of values 8–15) to indicate this type. A trigger frame with the Cross-MLD Trigger type indicates that the trigger is not ultimately intended for the radio operating in the sub-7 GHz band from which the trigger frame is transmitted, but rather is intended to trigger a TB-PPDU response in the ImmW band. This enables an AP operating as an MLD to coordinate UL ImmW transmissions from a client device’s ImmW radio using signaling sent over a sub-7 GHz link.

The UL BW field 404 indicates the uplink bandwidth for the triggered transmission. In existing trigger frame formats, the values of the UL BW field 404 indicate bandwidths of 20 MHz, 40 MHz, 80 MHz, and 80+80 MHz or 160 MHz for values of zero, one, two, and three, respectively. Because ImmW operation employs substantially wider channels, the values of the UL BW field 404 are redefined for the ImmW context: a value of zero indicates 160 MHz, a value of one indicates 320 MHz, a value of two indicates 640 MHz, and a value of three indicates 1280 MHz. In another embodiment, only three bandwidth values are defined within the UL BW field 404, with value zero indicating 160 MHz, value one indicating 320 MHz, value two indicating 640 MHz, and value three reserved for future use. In yet another embodiment, the UL BW field 404 is reduced to a one-bit field for indicating a UL BW of either 160 MHz or 320 MHz.

In some embodiments, the GI and HE-LTF Type/TXS Mode field 406 is removed or repurposed because the subcarrier spacing in ImmW is based on a static, upclocked integer multiple of the VHT subcarrier spacing and therefore does not require dynamic per-packet signaling of HE-LTF type or TXS mode. In other embodiments, the GI and HE-LTF Type/TXS Mode field 406 is reduced to a single-bit field for indicating a guard interval (GI) of either 400 ns or 800 ns, analogous to the GI indication used in VHT operation.

The Number of HE-LTF Symbols and Midamble Periodicity field 408 is reduced from three bits in length to one bit in length for ImmW operation. When the Doppler field 420 is set to zero, the Number of HE-LTF Symbols and Midamble Periodicity field 408 indicates the number of HE-LTF (or EHT-LTF) symbols. Because ImmW supports at most two spatial streams, only two values are needed: the field is set to zero to indicate one symbol, or one to indicate two symbols. When the Doppler field 420 is set to one, the Number of HE-LTF Symbols and Midamble Periodicity field 408 indicates both the number of HE-LTF (or EHT-LTF) symbols and the midamble periodicity. However, because ImmW supports at most two spatial streams, the midamble periodicity does not vary (e.g., is always a 10-symbol midamble periodicity), and therefore the field again requires only one bit: zero to indicate one symbol and one to indicate two symbols. The one-bit field thus provides complete signaling coverage for both Doppler field 420 values.

The UL STBC field 410 is removed or repurposed because STBC is not used in ImmW operation, which is limited to LDPC coding only.

In some embodiments, the LDPC Extra Symbol Segment field 412 is removed or set to a fixed value (e.g., always one), as dynamic per-packet signaling of this field is unnecessary in the ImmW context where LDPC coding is the only supported coding scheme. Setting this field to a fixed value of one provides the ancillary effect of including extra parity bits without requiring explicit per-packet signaling.

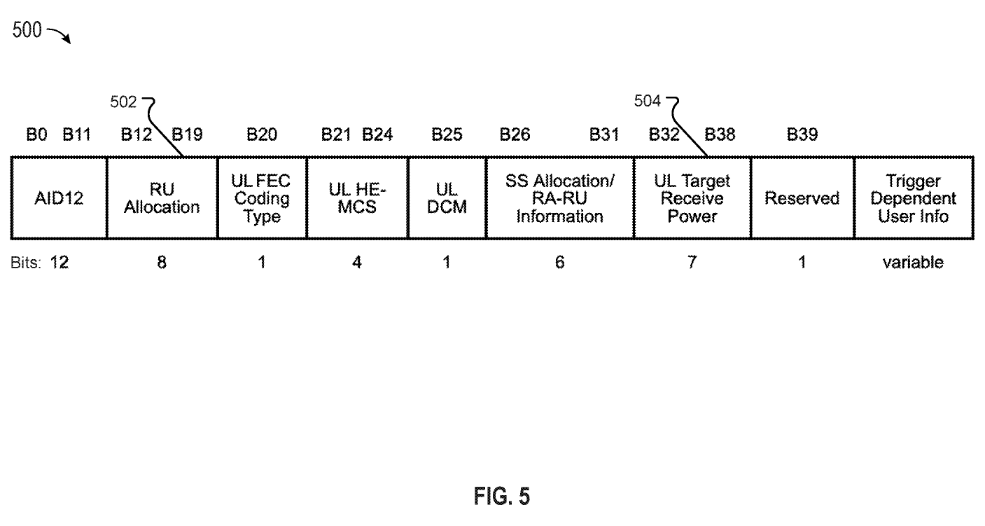

FIG. 5 illustrates a user info field 500 of a trigger frame. As illustrated, the user info field 500 includes, among other fields, an RU allocation field 502 and a UL Target Receive Power field 504. The RU allocation field 502 specifies the resource unit (RU) to be used by the triggered device for its UL transmission, and the UL Target Receive Power field 504 specifies the target received signal power level at the AP. Because these fields were designed to support MU resource scheduling and per-user power control, and because ImmW operation is restricted to SU transmissions, the RU allocation field 502 and the UL Target Receive Power field 504 are no longer needed in the ImmW context and may be repurposed or removed for ImmW-specific use.

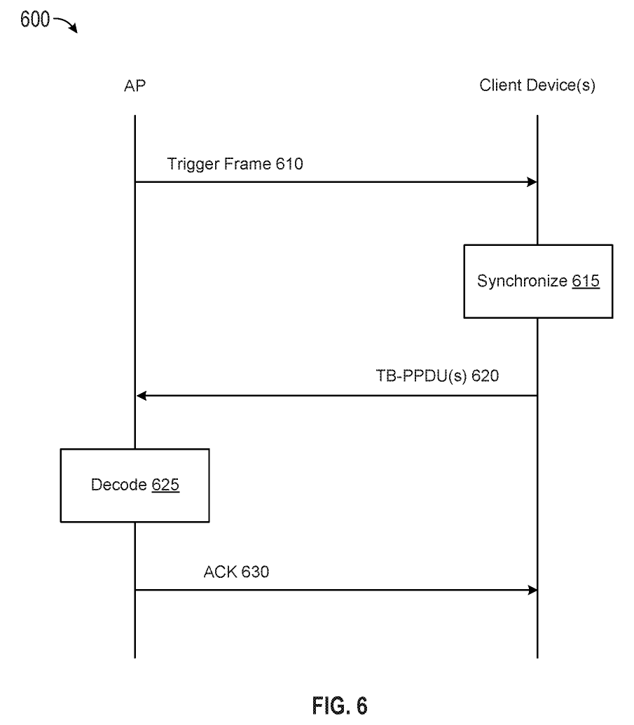

FIG. 6 illustrates a signaling process 600 for supporting TB-PPDUs in ImmW operation. The signaling process 600 is performed between an AP (e.g., the first AP 115, the second AP 120, or the third AP 125) and a client device (e.g., the first client device 130, the second client device 135, or the third client device 140).

In operation 610, the AP sends a trigger frame to the client device. The trigger frame includes the common info field 400 and the user info field 500, as modified for ImmW operation as described above with respect to FIGS. 4 and 5. In one embodiment (an ImmW in-band scenario), the AP sends the trigger frame in the ImmW band as an upclocked VHT-format DL PPDU. The Trigger Type field 402 of the common info field 400 is set to the ImmW in-band trigger type, indicating that the trigger is intended to trigger an upclocked VHT-format SU TB-PPDU response in the ImmW band and that the trigger frame does not include HE/EHT-specific fields. In another embodiment (a Cross-MLD scenario), the AP sends the trigger frame in a sub-7 GHz band as an HE or EHT PPDU. In this case, the Trigger Type field 402 is set to the Cross-MLD Trigger type, indicating that the trigger is not intended for the sub-7 GHz radio but is instead intended to trigger a TB-PPDU response in the ImmW band. In either embodiment, the UL BW field 404 is set to the appropriate value to indicate the applicable ImmW uplink channel bandwidth (e.g., 160 MHz, 320 MHz, 640 MHz, or 1280 MHz).

In operation 615, the client device receives and decodes the trigger frame, identifying the trigger type, UL bandwidth, and any other relevant transmission parameters. In the ImmW in-band scenario, the client device’s ImmW radio decodes the trigger frame directly from the ImmW band. In the Cross-MLD scenario, the client device operating as an MLD receives the trigger frame on its sub-7 GHz radio and passes the relevant triggering information to its ImmW radio. In both cases, the client device determines the timing and parameters for its UL TB-PPDU response.

In operation 620, the client device sends a TB-PPDU to the AP in the ImmW band. The TB-PPDU is an upclocked VHT-format SU PPDU comprising the VHT-SIG-A1 symbol 200 and the VHT-SIG-A2 symbol 300, with VHT-SIG-A fields modified as described above with respect to FIGS. 2 and 3. Specifically, the UL/DL bit within the VHT-SIG-A is set to the second value (e.g., 1) to indicate a UL transmission, and the Format bit is set to the second value (e.g., 1) to indicate that the PPDU is trigger-based.

In operation 625, the AP receives and decodes the TB-PPDU. The AP decodes the VHT-SIG-A fields of the TB-PPDU, including the UL/DL bit and the Format bit, to confirm that the PPDU is a trigger-based UL transmission. The AP then proceeds to decode the data payload of the TB-PPDU.

In operation 630, the AP sends an acknowledgment (e.g., a Block Acknowledge frame) to the client device to confirm successful reception of the TB-PPDU.

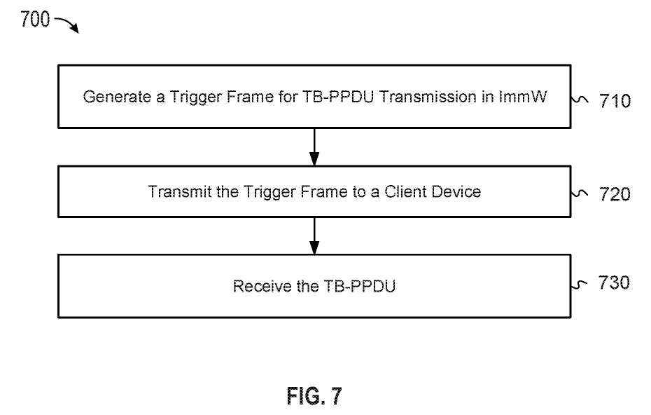

FIG. 7 illustrates a method 700 performed by an AP for supporting TB-PPDUs in ImmW operation. The method 700 may be performed by, for example, the first AP 115, the second AP 120, or the third AP 125 of FIG. 1.

In stage 710, the AP generates a trigger frame scheduling a UL transmission from a client device in an ImmW frequency band. The ImmW frequency band may be between 42 GHz and 71 GHz, including for example at 60 GHz. As described in further detail below, the trigger frame comprises a common info field modified for ImmW operation and, in some embodiments, a user info field modified for ImmW operation.

In stage 720, the AP transmits the trigger frame to the client device. In one embodiment, the AP transmits the trigger frame in the ImmW frequency band. In another embodiment, the AP transmits the trigger frame in a sub-7 GHz frequency band, for example where the AP and the client device are each implemented as Multi-Link Devices (MLDs) operating concurrently over sub-7 GHz and ImmW links.

In stage 730, the AP receives, from the client device in response to the trigger frame, a TB-PPDU in the ImmW frequency band.

In some embodiments, the TB-PPDU comprises a SIG field of a physical layer preamble comprising a first repurposed bit set to a value indicating a transmission direction of the TB-PPDU and a second repurposed bit set to a value indicating that the TB-PPDU is trigger-based. The first repurposed bit may be a UL/DL bit set to a first value (e.g., 0) to indicate a DL transmission or a second value (e.g., 1) to indicate a UL transmission. The second repurposed bit may be a Format bit set to a first value (e.g., 0) to indicate the PPDU is not trigger-based or a second value (e.g., 1) to indicate the PPDU is trigger-based.

In some embodiments, the SIG field is a VHT-SIG field comprising a VHT-SIG-A1 symbol and a VHT-SIG-A2 symbol. In some such embodiments, the first repurposed bit and the second repurposed bit are in at least one of: a Group ID field of the VHT-SIG-A1 symbol, an STBC bit of the VHT-SIG-A1 symbol, an NSS field of the VHT-SIG-A1 symbol, one or more reserved bits of the VHT-SIG-A1 symbol, an MCS field of the VHT-SIG-A2 symbol, or a reserved bit of the VHT-SIG-A2 symbol. In some embodiments, the SIG field may be an HE-SIG field of an HE-format PHY frame or a U-SIG field of an EHT-format PHY frame, with the first and second repurposed bits drawn from analogous unused or inapplicable bits of those fields.

In some embodiments, the trigger frame of stage 720 is transmitted in the ImmW frequency band and comprises a common info field comprising a Trigger Type field set to a value indicating an ImmW in-band trigger type. The ImmW in-band trigger type indicates that the trigger frame is intended to trigger an upclocked VHT-format SU TB-PPDU in the ImmW frequency band and that the common info field does not include HE or EHT-specific fields.

In some embodiments, the trigger frame of stage 720 is transmitted in a sub-7 GHz frequency band and comprises a common info field comprising a Trigger Type field set to a value indicating a Cross-MLD Trigger type. The Cross-MLD Trigger type indicates that the trigger frame is not intended for the radio operating in the sub-7 GHz frequency band but is instead intended to trigger the TB-PPDU from the client device in the ImmW frequency band.

In some embodiments, the common info field of the trigger frame comprises a UL BW field indicating a channel bandwidth applicable to ImmW operation. In one embodiment, the UL BW field indicates a channel bandwidth of at least 160 MHz for transmitting the TB-PPDU, with field values indicating 160 MHz, 320 MHz, 640 MHz, and 1280 MHz for values zero, one, two, and three, respectively. In another embodiment, a fourth value of the UL BW field is reserved. In yet another embodiment, the UL BW field is reduced to a single bit, with a first value indicating 160 MHz and a second value indicating 320 MHz.

In some embodiments, the common info field of the trigger frame comprises at least one of: a GI field that is one bit in length, indicating a GI of 400 ns or 800 ns; no UL STBC field, or a repurposed STBC bit, because ImmW operation is restricted to LDPC coding only; no LDPC Extra Symbol Segment field, or an LDPC Extra Symbol Segment field set to a fixed value; or a Number of HE-LTF Symbols and Midamble Periodicity field that is one bit in length, with a first value indicating one LTF symbol and a second value indicating two LTF symbols, wherein the field is reduced to one bit because ImmW operation supports at most two spatial streams and, when a Doppler field of the common info field is set to one, midamble periodicity is fixed and not separately signaled.

In some embodiments, the trigger frame comprises a user info field comprising at least one of: no RU allocation field, or a repurposed RU allocation field; or no UL Target Receive Power field, or a repurposed UL Target Receive Power field. The RU allocation field and UL Target Receive Power field are inapplicable in the ImmW context because ImmW operation is restricted to SU transmissions.

FIG. 8 is a block diagram of a computing device 800. As shown in FIG. 8, computing device 800 may include a processing unit 810 and a memory unit 815. Memory unit 815 may include a software module 820 and a database 825. While executing on processing unit 810, software module 820 may perform, for example, processes for supporting TB-PPDUs in ImmW operation. Computing device 800, for example, may provide an operating environment for the controller 105, the database 107, the first AP 115, the second AP 120, the third AP 125, the first client device 130, the second client device 135, the third client device 140, and the like. The controller 105, the database 107, the first AP 115, the second AP 120, the third AP 125, the first client device 130, the second client device 135, the third client device 140, and the like may operate in other environments and are not limited to computing device 800.

Computing device 800 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 800 may comprise any computer operating environment, such as hand-held devices, multiprocessor systems, microprocessor-based or programmable sender electronic devices, minicomputers, mainframe computers, and the like. Computing device 800 may also be practiced in distributed computing environments where tasks are performed by remote processing devices. The aforementioned systems and devices are examples, and computing device 800 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 800 on the single integrated circuit (chip).

FIG. 9 illustrates an implementation of a communications device 900 that may implement one or more of the controller 105, the database 107, the first AP 115, the second AP 120, the third AP 125, the first client device 130, the second client device 135, the third client device 140, etc. In various implementations, the communications device 900 may comprise a logic circuit. The logic circuit may include physical circuits to perform operations described for one or more of the controller 105, the database 107, the first AP 115, the second AP 120, the third AP 125, the first client device 130, the second client device 135, the third client device 140, etc., for example. As shown in FIG. 9, the communications device 900 may include one or more of, but is not limited to, a radio interface 910, baseband circuitry 930, and/or the computing device 800.

The communications device 900 may implement some or all of the structures and/or operations for the controller 105, the database 107, the first AP 115, the second AP 120, the third AP 125, the first client device 130, the second client device 135, the third client device 140, etc., storage medium, and logic circuit in a single computing entity, such as entirely within a single device. Alternatively, the communications device 900 may distribute portions of the structure and/or operations using a distributed system architecture, such as a client station server architecture, a peer-to-peer architecture, a master-slave architecture, etc.

A radio interface 910, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 910 may include, for example, a receiver 915 and/or a transmitter 920. The radio interface 910 may include bias controls, a crystal oscillator, and/or one or more antennas 925. In additional or alternative configurations, the radio interface 910 may use oscillators and/or one or more filters, as desired.

The baseband circuitry 930 may communicate with the radio interface 910 to process, receive, and/or transmit signals and may include, for example, an Analog-To-Digital Converter (ADC) for down converting received signals with a Digital-To-Analog Converter (DAC) 935 for up converting signals for transmission. Further, the baseband circuitry 930 may include a baseband or PHY layer processing circuit for the PHY link layer processing of respective receive/transmit signals. Baseband circuitry 930 may include, for example, a MAC processing circuit 940 for MAC/data link layer processing. Baseband circuitry 930 may include a memory controller for communicating with MAC processing circuit 940 and/or a computing device 800, for example, via one or more interfaces 945.

In some configurations, PHY processing circuit may include a frame construction and/or detection module, in combination with additional circuitry such as a buffer memory, to construct and/or deconstruct communication frames. Alternatively or in addition, MAC processing circuit 940 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
generating, by an access point (AP), a trigger frame scheduling an uplink (UL) transmission from a client device in an Integrated millimeter Wave (ImmW) frequency band;
transmitting, by the AP, the trigger frame to the client device; and
receiving, by the AP in response to the trigger frame, a trigger-based physical layer protocol data unit (TB-PPDU) from the client device, wherein the TB-PPDU comprises a signal (SIG) field of a physical layer preamble comprising a first repurposed bit set to a value indicating a transmission direction of the TB-PPDU and a second repurposed bit set to a value indicating that the TB-PPDU is trigger-based.

2. The method of claim 1, wherein the SIG field is a very high throughput (VHT)-SIG field comprising a VHT-SIG-A1 symbol and a VHT-SIG-A2 symbol.

3. The method of claim 2, wherein the first repurposed bit and the second repurposed bit are in at least one of: a group identifier field of the VHT-SIG-A1 symbol, a space-time block coding (STBC) bit of the VHT-SIG-A1 symbol, a number of spatial streams (NSS) field of the VHT-SIG-A1 symbol, one or more reserved bits of the VHT-SIG-A1 symbol, a modulation and coding scheme (MCS) field of the VHT-SIG-A2 symbol, or a reserved bit of the VHT-SIG-A2 symbol.

4. The method of claim 1, wherein the trigger frame is transmitted in the ImmW frequency band and comprises a common info field, the common info field comprising a trigger type field set to a value indicating an ImmW in-band trigger type, the ImmW in-band trigger type indicating that the trigger frame is intended to trigger an upclocked VHT-format single-user (SU) TB-PPDU in the ImmW frequency band.

5. The method of claim 1, wherein the trigger frame is transmitted in a sub-7 GHz frequency band and comprises a common info field, the common info field comprising a trigger type field set to a value indicating a cross-multi-link device (MLD) trigger type, the cross-MLD trigger type indicating that the trigger frame intended to trigger the TB-PPDU from the client device in the ImmW frequency band.

6. The method of claim 1, wherein the trigger frame comprises a common info field comprising an uplink bandwidth (UL BW) field, wherein the UL BW field indicates a channel bandwidth of at least 160 Megahertz (MHz) for transmitting the TB-PPDU.

7. The method of claim 1, wherein the trigger frame comprises a common info field comprising at least one of: a guard interval field that is one bit in length, no UL STBC field, a repurposed STBC bit, no low-density parity-check field, or a number of high efficiency-long training field symbols and midamble periodicity field that is one bit in length.

8. The method of claim 1, wherein the trigger frame comprises a user info field comprising at least one of: no resource unit (RU) allocation field, a repurposed RU allocation field, no UL target receive power field, or a repurposed UL target receive power field.

9. A system comprising:
a memory storage; and
a processing unit coupled to the memory storage, wherein the processing unit is operative to:
generate a trigger frame scheduling an uplink (UL) transmission from a client device in an Integrated millimeter Wave (ImmW) frequency band;
transmit the trigger frame to the client device; and
receive, in response to the trigger frame, a trigger-based physical layer protocol data unit (TB-PPDU) from the client device, wherein the TB-PPDU comprises a signal (SIG) field of a physical layer preamble comprising a first repurposed bit set to a value indicating a transmission direction of the TB-PPDU and a second repurposed bit set to a value indicating that the TB-PPDU is trigger-based.

10. The system of claim 9, wherein the SIG field is a very high throughput (VHT)-SIG field comprising a VHT-SIG-A1 symbol and a VHT-SIG-A2 symbol.

11. The system of claim 10, wherein the first repurposed bit and the second repurposed bit are in at least one of: a group identifier field of the VHT-SIG-A1 symbol, a space-time block coding (STBC) bit of the VHT-SIG-A1 symbol, a number of spatial streams (NSS) field of the VHT-SIG-A1 symbol, one or more reserved bits of the VHT-SIG-A1 symbol, a modulation and coding scheme (MCS) field of the VHT-SIG-A2 symbol, or a reserved bit of the VHT-SIG-A2 symbol.

12. The system of claim 9, wherein the trigger frame is transmitted in the ImmW frequency band and comprises a common info field, the common info field comprising a trigger type field set to a value indicating an ImmW in-band trigger type, the ImmW in-band trigger type indicating that the trigger frame is intended to trigger an upclocked VHT-format single-user (SU) TB-PPDU in the ImmW frequency band.

13. The system of claim 9, wherein the trigger frame is transmitted in a sub-7 GHz frequency band and comprises a common info field, the common info field comprising a trigger type field set to a value indicating a cross-multi-link device (MLD) trigger type, the cross-MLD trigger type indicating that the trigger frame intended to trigger the TB-PPDU from the client device in the ImmW frequency band.

14. The system of claim 9, wherein the trigger frame comprises a common info field comprising at least one of: a guard interval field that is one bit in length, no UL STBC field, a repurposed STBC bit, no low-density parity-check field, or a number of high efficiency-long training field symbols and midamble periodicity field that is one bit in length.

15. A method comprising:
generating, by an access point (AP), a trigger frame scheduling an uplink (UL) transmission from a client device in an Integrated millimeter Wave (ImmW) frequency band, wherein the trigger frame comprises a common info field including at least one of: a guard interval field that is one bit in length, no UL STBC field, a repurposed STBC bit, no low-density parity-check field, or a number of high efficiency-long training field symbols and midamble periodicity field that is one bit in length;
transmitting, by the AP, the trigger frame to the client device; and
receiving, by the AP in response to the trigger frame, a trigger-based physical layer protocol data unit (TB-PPDU) from the client device.

16. The method of claim 15, wherein the trigger frame is transmitted in the ImmW frequency band and the common info field comprises a trigger type field set to a value indicating an ImmW in-band trigger type, the ImmW in-band trigger type indicating that the trigger frame is intended to trigger an upclocked VHT-format single-user (SU) TB-PPDU in the ImmW frequency band.

17. The method of claim 15, wherein the trigger frame is transmitted in a sub-7 GHz frequency band and the common info field comprises a trigger type field set to a value indicating a cross-multi-link device (MLD) trigger type, the cross-MLD trigger type indicating that the trigger frame intended to trigger the TB-PPDU from the client device in the ImmW frequency band.

18. The method of claim 15, wherein the common info field comprises an uplink bandwidth (UL BW) field, wherein the UL BW field indicates a channel bandwidth of at least 160 Megahertz (MHz) for transmitting the TB-PPDU.

19. The method of claim 15, wherein the common info field comprises an uplink bandwidth (UL BW) field, wherein the UL BW field indicates a channel bandwidth of at least 160 Megahertz (MHz) for transmitting the TB-PPDU.

20. The method of claim 15, wherein the TB-PPDU comprises a signal (SIG) field of a physical layer preamble comprising a first repurposed bit set to a value indicating a transmission direction of the TB-PPDU and a second repurposed bit set to a value indicating that the TB-PPDU is trigger-based.
